(19) United States
(12) Patent Application Publication
(10) Pub. No.: US 2019/0104101 A1
(43) Pub. Date: Apr. 4, 2019

(54) PAIRED EFFECTS IN CONVERSATIONS BETWEEN USERS

(71) Applicant: Facebook, Inc., Menlo Park, CA (US)

(72) Inventors: Hermes Germi Pique Corchs, Mountain View, CA (US); Ruoruo Zhang, Santa Clara, CA (US)

(21) Appl. No.: 15/725,037

(22) Filed: Oct. 4, 2017

(51) Int. Cl. H04L 12/58

(52) U.S. Cl. CPC H04L 51/32; G06Q 50/01; H04L 51/36; H04L 51/10

(57) ABSTRACT

The present disclosure relates generally to increasing engagement in conversations between users, and more particularly to providing an effect to a second user in response to use of an effect by a first user. In certain embodiments, two or more users may be having a conversation via a communication platform of an SNS. The conversation may be streaming (e.g., a video or audio call) or non-streaming (e.g., a message exchange). During the conversation, a first user may send a communication that includes content with a first effect applied thereto. Based on the communication, a second effect corresponding to the first effect may be identified for use by the second user in response to the communication. The second effect may then be provided to the second user so that the second user may use the second effect in response to the communication.

### BACKGROUND

A social networking system (SNS) may enable its users to interact with and share information with each other through various interfaces provided by the SNS. For example, the information may be shared through a communication platform, which enables users of the SNS to communicate with each other. In some examples, the communication platform may facilitate an exchange of messages between users of the SNS. In other examples, the communication platform may facilitate a streaming conversation (such as a video call between the users). With either form of communication, the SNS is always looking for new services to provide its users to enhance the users' experience with the communication platform.

### SUMMARY

The present disclosure relates generally to techniques for enhancing communications between users, and more particularly to enabling paired effects to be applied to communications between users. The use of paired effects may enhance the users' overall communication experience and drive increased user engagement.

In certain embodiments, a pair of effects is provided, where a first effect from the pair is used to modify first content that is communicated from a first user to a second user during a conversation between the first user and the second user, and where a second effect from the pair is used to modify second content that is communicated from the second user to the first user as a response to the first content. Various inventive embodiments regarding paired effects are described herein, including methods, systems, non-transitory computer-readable storage media storing programs, code, or instructions executable by one or more processors, and the like.

An effect, as used herein, modifies content to create modified content. The content being modified may be referred to as “original” content to differentiate it from modified content that is generated from applying the effect to the original content. For example, an effect may modify an audio or visual component of original content to create modified content. In such an example, modifying may include adding, deleting, or changing the audio or visual component.

In certain embodiments, the ability to use the paired effects may be provided to users of a social networking system (SNS) via a communication platform (e.g., a messaging service, an instant messaging service, or an audio/video call service). The communication platform may enable a conversation between two or more users and allow for paired effects to be used to enhance communications as part of the conversation. For example, the communication platform may enable users to browse content, post and send communications, retrieve and sort communications received from other users, maintain continuous communications between users, or the like. In such an example, a user may have a mailbox that includes communications that are both sent and received by the user.

Communications may be in any suitable format, such as electronic mail (“e-mail”) messages, chat messages, comments left on a user's webpage, short message service (SMS) text messages, visual packets, audio packets, or the like. Messages may include text or other content such as pictures, videos, sounds, or attachments.

In some embodiments, a first user and a second user may be having a message conversation via a communication platform. The conversation may be in the form of messages that are exchanged between the first user and the second user. During such a conversation, the first user may send a first message to the second user, where the first message includes modified first content resulting from application of a first effect from a pair of effects. The first effect may be applied to first content provided by the first user, and the modified first content may be communicated to the second user in the first message. A second effect may be identified as being paired with the first effect. The second effect may be used to modify second content provided by the second user as a response to the first message, and the modified second content may be communicated from the second user to the first user in a second message.

In one illustrative example, a first user may take a picture of herself. The first user may then digitally add a hat to the picture such that the hat appears to be on the head of the first user in the picture. The first user may then send the picture to a second user. After viewing the picture, the second user may generate a response to the picture. The response may be a picture of the second user with a bandana digitally added to herself. The bandana may have been suggested to the second user in response to the picture from the first user. The suggestion may be based on the hat being added to the picture from the first user. The second user may then send the response to the first user.

In other embodiments, a first user and a second user may have a conversation via an audio and/or video call using the communication platform. For example, the call may be established between the first user and the second user such that content from each user is continuously sent to each other user. While not required, the call may be facilitated by a SNS. During such a conversation, the first user may select a first effect to be applied to first content sent from the first user to the second user. The first effect may be applied to the first content, which is communicated to the second user via the call. The modified first content may include one or more communications from the first user to the second user. For example, the modified first content may span several seconds of content.

A second effect may be identified as being paired with the first effect. The second effect may be used by the second user to modify second content provided by the second user in response to the first effect being used, the modified second content communicated from the second user to the first user via the call. In some cases, the modified first content and the modified second content may be sent between the user devices at least partially concurrently.

In one illustrative example, a first user and a second user may establish a video call with each other. The video call may include first content being sent from the first user to the second user and second content being sent from the second user to the first user. The first content may be of the first user, and the second content may be of the second user. The first user may then digitally add a first type of dog ears to herself such that the dog ears appear to be on the head of the first user during the video call. After viewing the first type of dog ears, the second user may be presented an option to put a second type of dog ears on herself, the second type of dog ears corresponding to the first type of dog ears. After selection of the option, the second type of dog ears may be digitally added to herself such that the second type of dog ears appear to be on the head of the second user during the video call.

According to embodiments described above, techniques may be provided for using paired effects during a conversation between users of a social networking system (SNS). For example, techniques may include determining, at a computer system, that modified first content communicated from a first user to a second user has been generated by applying a first effect to first content. The first user may be associated with a first account of the social networking system and the second user may be associated with a second account of the social networking system. The first effect may modify an audio portion or a visual portion of the first content.

In some embodiments, the conversation may be streaming (i.e., the first user and the second user may be participating in a streaming conversation). In such embodiments, the modified first content may be a portion of the streaming conversation and the modified second content may be a different portion of the streaming conversation. When the conversation is a streaming conversation, the computer system may receive a request to establish the streaming conversation between the first user and the second user prior to the streaming conversation being initiated. In response to the request, the streaming conversation may be established between the first user and the second user. In other embodiments, the conversation may be non-streaming (i.e., the modified first content is communicated from the first user to the second user in a first message).

A second effect corresponding to the first effect may be identified. The second effect may be different than the first effect. In some embodiments, the second effect may be identified based on the first effect. In other embodiments, the second effect is identified based on logic defined for the first effect. In other embodiments, the second effect is identified based on information associated with the first user or the second user. Identifying the second effect may be performed in response to the first user communicating the modified first content. The computer system may then enable generation of modified second content, the modified second content generated by applying the second effect to second content provided by the second user in response to the modified first content. Enabling generation of the modified second content may include providing logic for implementing the second effect to the second user.

Techniques may further include enabling communication of the modified first content from the first user to the second user and enabling communication of the modified second content from the second user to the first user. Techniques may further include receiving a request for the second effect by the computer system and sending logic for implementing the second effect by the computer system to the second user. Techniques may further include receiving a request for the first effect by the computer system from the first user and sending logic for implementing the first effect by the computer system to the first user. Techniques may further include receiving the modified first content by the computer system from the first user and sending the modified first content by the computer system to the second user.

Other techniques provided may include receiving modified first content from a first user. The modified first content may be received by a device associated with the second user. The modified first content may be generated by applying a first effect to first content. Similar to above, a second effect corresponding to the first effect may be identified. However, rather than a computer system distinct from the second user identifying the second effect, the device associated with the second user may identify the second effect. In response to receiving the modified first content, modified second content may be generated by applying the second effect to second content. The generating may be performed by the device. The device may then cause the modified second content to be communicated to the first user.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 is a simplified block diagram of a distributed system with a first user device directly communicating with a second user device according to certain embodiments.

FIG. 2 is a simplified flowchart depicting processing performed by a second user device for implementing paired effects according to certain embodiments.

FIG. 3 is a simplified block diagram of a distributed system with a social networking system according to certain embodiments.

FIG. 4A is a simplified flowchart depicting processing performed in a distributed system for implementing paired effects when content is modified on a user device according to certain embodiments.

FIG. 4B is a simplified flowchart depicting processing performed in a distributed system for implementing paired effects when modified content is selected on a user device according to certain embodiments.

FIG. 5 is a simplified block diagram of a distributed system with a social networking system managing communications in the distributed system according to certain embodiments.

FIG. 6A is a simplified flowchart depicting processing performed in a distributed system for implementing paired effects with a social networking system managing communications in the distributed system when content is modified on a user device according to certain embodiments.

FIG. 6B is a simplified flowchart depicting processing performed in a distributed system for implementing paired effects with a social networking system managing communications in the distributed system when modified content is selected on a user device according to certain embodiments.

FIG. 7 is a simplified flowchart depicting processing performed by a social networking system for implementing paired effects according to certain embodiments.

FIG. 8A is an example of modified content based on an effect of a pair of effects according to certain embodiments.

FIG. 8B is another example of modified content based on an effect of a pair of effects according to certain embodiments.

FIG. 9 illustrates an example of a computer system that may be used to implement certain embodiments described herein.

### DETAILED DESCRIPTION

The present disclosure relates generally to techniques for enhancing communications between users, and more particularly to enabling paired effects to be applied to communications between users. The use of paired effects may enhance the users' overall communication experience and drive increased user engagement.

In certain embodiments, a pair of effects is provided, where a first effect from the pair is used to modify first content that is communicated from a first user to a second user during a conversation between the first user and the second user and where a second effect from the pair is used to modify second content that is communicated from the second user to the first user as a response to the first content. Various inventive embodiments regarding paired effects are described herein, including methods, systems, non-transitory computer-readable storage media storing programs, code, or instructions executable by one or more processors, and the like.

An effect, as used herein, modifies content to create modified content. The content being modified may be referred to as “original” content to differentiate it from modified content that is generated from applying the effect to the original content. For example, an effect may modify an audio or a visual component of original content to create modified content. In such an example, modifying may include adding, deleting, or changing the audio or the visual component.

In certain embodiments, the ability to use the paired effects may be provided to users of a social networking system (SNS) via a communication platform (e.g., a messaging service, an instant messaging service, or an audio/video call service). The communication platform may enable a conversation between two or more users and allow for paired effects to be used to enhance communications as part of the conversation. For example, the communication platform may enable users to browse content, post and send communications, retrieve and sort communications received from other users, maintain continuous communications between users, and the like. In such an example, a user may have a mailbox that includes communications that are both sent and received by the user.

Communications may be in any suitable format such as electronic mail (“e-mail”) messages, chat messages, comments left on a user's webpage, short message service (SMS) text messages, video packets, audio packets, or the like. Messages may include text or other content such as pictures, videos, sounds, and attachments.

In some embodiments, a first user and a second user may be having a conversation via the communication platform. The conversation may be in the form of messages that are exchanged between the first user and the second user. During such a conversation, the first user may send a first message to the second user, where the first message includes modified first content resulting from application of a first effect from a pair of effects. For example, the first effect may be applied to first content provided by the first user, and the modified first content may be communicated to the second user in the first message. A second effect may be identified as being paired with the first effect. The second effect may be used to modify second content provided by the second user as a response to the first message, and the modified second content may be communicated from the second user to the first user in a second message.

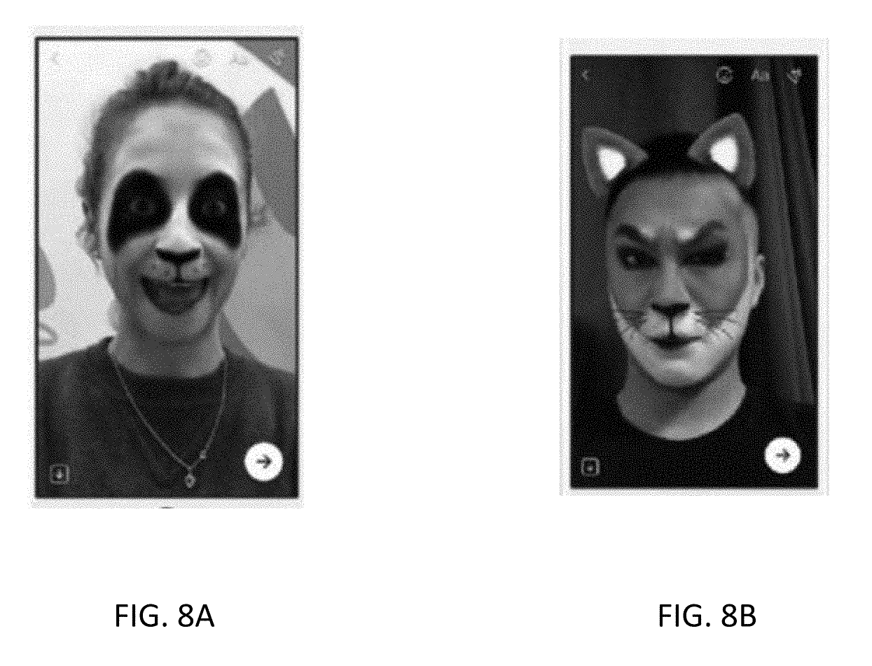

In one illustrative example, a first user may take a first picture of herself. The first user may then digitally add a panda face to the first picture, as depicted in FIG. 8A. The first user may then send the first picture with the panda face to a second user. After viewing the first picture, the second user may generate a response to the first picture. The response may be a second picture of the second user with a fox face digitally added to the second picture, as depicted in FIG. 8B. The fox face may have been suggested to the second user in response to the first picture. The suggestion may be based on the effect panda face being added to the first picture. The second user may then send the response to the first user.

In other embodiments, a first user and a second user may have a conversation via an audio and/or video call using the communication platform. For example, the call may be established between the first user and the second user such that content from each user is continuously sent to each other user. While not required, the call may be facilitated by a SNS. During such a conversation, the first user may select a first effect to be applied to first content sent from the first user to the second user. The first effect may be applied to the first content, which is communicated to the second user via the call. The modified first content may include one or more communications from the first user to the second user. For example, the modified first content may span several seconds of content.

A second effect may be identified as being paired with the first effect. The second effect may be used by the second user to modify second content provided by the second user in response to the first effect being used, the modified second content communicated from the second user to the first user via the call. In some cases, the modified first content and the modified second content may be sent between the user devices at least partially concurrently.

In one illustrative example, a first user and a second user may establish a video call with each other. The video call may include first content being sent from the first user to the second user and second content being sent from the second user to the first user. The first content may be of the first user, and the second content may be of the second user. The first user may then digitally add a first type of dog ears to herself such that the dog ears appear to be on the head of the first user during the video call. After viewing the first type of dog ears, the second user may be presented an option to put a second type of dog ears on herself, the second type of dog ears corresponding to the first type of dog ears. After selection of the option, the second type of dog ears may be digitally added to herself such that the second type of dog ears appear to be on the head of the second user during the video call.

In certain embodiments, a SNS may receive information from a first user identifying a first effect. The first effect may be applied to first content included in a communication from the first user to a second user. The SNS may, based upon the first content having the first effect applied thereto, identify a second effect corresponding to the first effect. The SNS may then cause logic implementing the second effect to be downloaded to a device used by the second user. In this manner, the second effect may be made available for use by the second user to respond to the communication. For example, the second user may send a communication to the first user in response to the communication from the first user, where the communication to the first user includes second content that has the second effect applied thereto.

In other embodiments, a SNS may receive a communication that includes modified first content. The SNS may determine that the first effect has been applied to the modified first content included in the first communication. The SNS may identify a second effect corresponding to the first effect. The SNS may then cause logic implementing the second effect to be downloaded to a device used by the second user. In this manner, the second effect may be made available for use by the second user to respond to the communication. For example, the second user may send a communication to the first user in response to the communication from the first user, where the communication to the first user includes second content that has the second effect applied thereto.

In embodiments described above, a SNS may use various techniques to identify a second effect corresponding to a first effect. For example, preconfigured “pairs information” may be accessible by the SNS, where the pairs information includes information identifying paired effects. The pairs information may be configured by an author of an effect, by an administrator or manager of the SNS, or by a user associated with an account of the SNS. For another example, “pair rules” may be accessible by the SNS, where, given an effect, the pair rules specify logic for identifying a paired effect corresponding to the effect. The pair rules may be based upon information associated with an account of the first user and/or an account of the second user available to the SNS (e.g., a user profile or a social graph associated with the SNS).

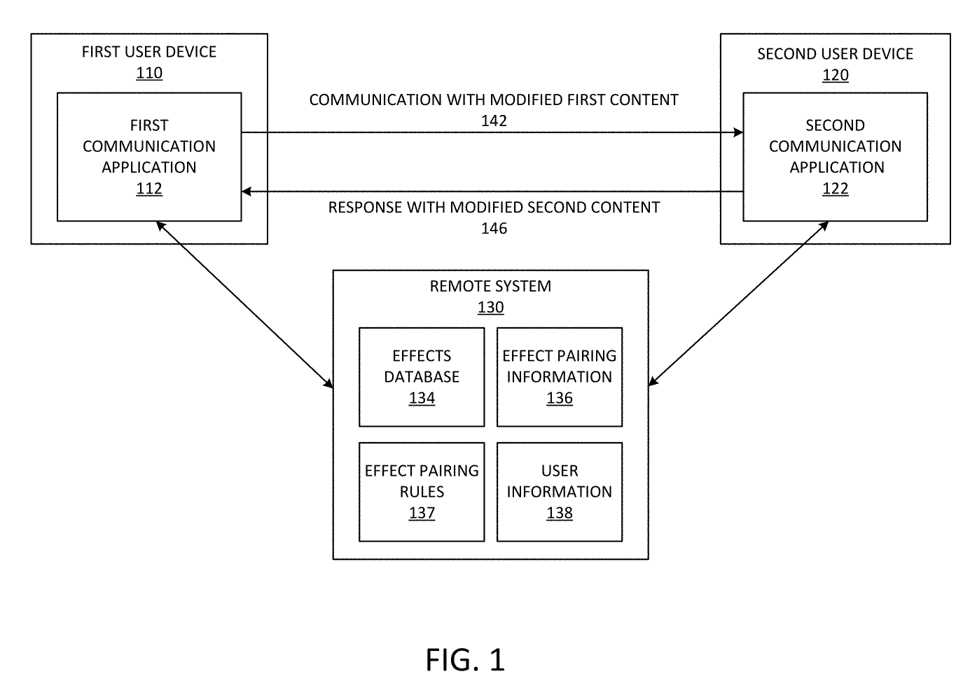

FIG. 1 is a simplified block diagram of a distributed system with first user device 110 directly communicating with second user device 120 according to certain embodiments. As an example, directly communicating may indicate that communications from first user device 110 to second user device 120 are not sent through a social networking system (SNS). Directly communicating does not mean that communications do not go through intermediary components, such as a router or the Internet.

The user devices 110, 120 depicted in FIG. 1 may be communicatively coupled with each other via one or more communication networks. Examples of a communication network include, without restriction, the Internet, a wide area network (WAN), a local area network (LAN), an Ethernet network, wireless wide-area networks (WWANs), wireless local area networks (WLANs), wireless personal area networks (WPANs), a public or private network, a wired network, a wireless network, the like, or combinations thereof. Different communication protocols may be used to facilitate communications including both wired and wireless protocols such as IEEE 802.XX suite of protocols, TCP/IP, IPX, SAN, AppleTalk®, Bluetooth®, InfiniBand, RoCE, Fiber Channel, Ethernet, User Datagram Protocol (UDP), Asynchronous Transfer Mode (ATM), token ring, frame relay, High Level Data Link Control (HDLC), Fiber Distributed Data Interface (FDDI), and/or Point-to-Point Protocol (PPP), and others. A WWAN may be a network using an air interface technology, such as, a code division multiple access (CDMA) network, a Time Division Multiple Access (TDMA) network, a Frequency Division Multiple Access (FDMA) network, an OFDMA network, a Single-Carrier Frequency Division Multiple Access (SC-FDMA) network, a WiMax (IEEE 802.16), and so on. A WLAN may include an IEEE 802.11x network (e.g., a Wi-Fi network). A WPAN may be a Bluetooth network, an IEEE 802.15x, or some other types of network.

A user device (sometimes referred to as a client device, a client, or a device) may be a computing device, such as, for example, a mobile phone, a smart phone, a personal digital assistant (PDA), a tablet computer, an electronic book (e-book) reader, a gaming console, a laptop computer, a netbook computer, a desktop computer, a thin-client device, a workstation, etc. One or more applications (“apps”) may be hosted and executed by the user device (e.g., first communication application 112 by first user device 110 and second communication application 122 by second user device 120). The apps may be web browser-based applications or other types of applications.

A communication application (e.g., communication applications 112, 122) may enable a conversation between user devices. The conversation may include one or more communications exchanged between the communication applications. Communications may be in any suitable format such as electronic mail (“e-mail”) messages, chat messages, comments left on a user's webpage, short message service (SMS) text messages, video packets, audio packets, or the like. For example, first communication application 112 may be communicating via a video call or an audio call with second communication application 122. For another example, first communication application 112 may be sending messages to second communication application 122. Messages may include text or other content such as pictures, videos, sounds, and attachments. When messages are communicated between users, a user may have a mailbox that includes messages that are both sent and received by the user.

As depicted in FIG. 1, first user device 110 may send communication 142 to second user device 120 via first communication application 112 and second communication application 122. Communication 142 may include modified first content. The modified first content may be first content that has been modified based on a first effect. For example, the first effect may modify an audio portion or a visual portion of the first content. In some embodiments, the modified first content may be generated by first user device 110. In other embodiments, the modified first content may be received by first user device 110 with the first effect already applied to the first content.

In addition to communication 142, first communication application 112 may send a communication to remote system 130. The communication to remote system 130 may be sent before, at the same time, or after communication 142 is sent to second user device 120. In some embodiments, the communication to remote system 130 may identify the first effect. When remote system 130 receives an identification of the first effect, remote system 130 may identify a second effect that corresponds to the first effect, as described further below. In other embodiments, the communication to remote system 130 may identify the second effect. In such embodiments, the second effect may be identified by first user device 110 as described below. In other embodiments, communication application 122 may send an identification of the first effect or the second effect to remote system 130 in response to receiving communication 142. In such embodiments, the second effect may be identified as described below.

The second effect may be identified using a variety of techniques. For example, effect pairing information (from effect pairing information database 136) may be used to identify the second effect. The effect pairing information may indicate effects that correspond to each other (e.g., that the second effect corresponds to the first effect). The effect pairing information may be configured by an author of an effect, by an administrator, or by a user (e.g., a first user operating first user device 110, a second user operating second user device 120, or a third user).

For another example, one or more effect pairing rules (from effect pairing rules database 137) may be used to identify the second effect. An effect pairing rule may include logic that identifies the second effect based on the first effect. In some cases, the logic may use information associated with the first effect, a first user who sent first content with the first effect applied thereto, a recipient of the modified first content sent by the first user, information associated with the first user and/or the second user, any combination thereof, or the like.

Upon receiving an indication of the second effect or identifying the second effect, remote system 130 may obtain logic to implement the second effect. The logic may be stored in effect database 134, which may be included with or remote from remote system 130. The logic may then be sent to second communication application 122 such that a user operating second communication application 122 may use the logic to modify second content based on the second effect. For example, a user may modify second content using the logic to generate modified second content. The modified second content may then be included in a response 146 and sent to first communication application 112 from second communication application 122.

The distributed system depicted in FIG. 1 is merely an example and is not intended to unduly limit the scope of inventive embodiments recited in the claims. One of ordinary skill in the art would recognize many possible variations, alternatives, and modifications. For example, in some implementations, the distributed system may have more or fewer user devices, may have more or fewer components, may combine two or more components, or may have a different configuration or arrangement than illustrated in FIG. 1.

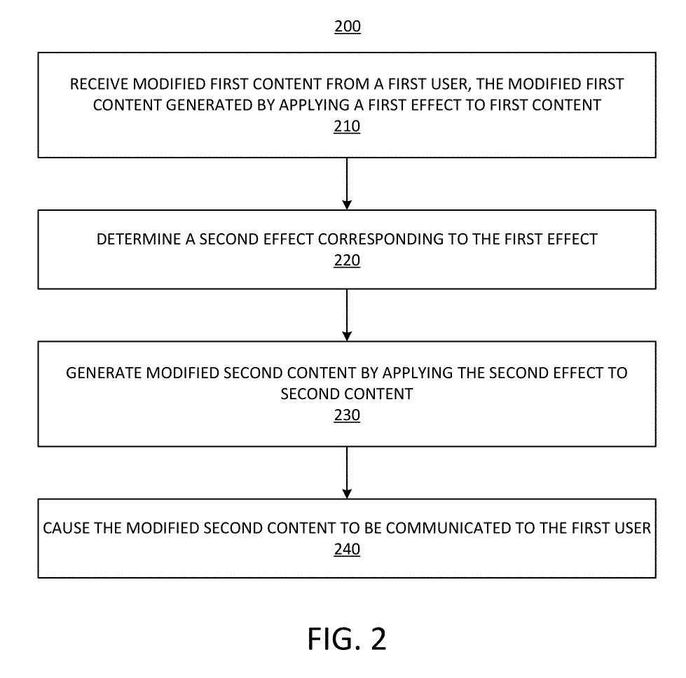

FIG. 2 is a simplified flowchart depicting processing performed by a second user device for implementing paired effects according to certain embodiments. The processing depicted in FIG. 2 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 2 and described below is intended to be illustrative and non-limiting. Although FIG. 2 depicts the various processing steps occurring in a particular sequence or order, this is not intended to be limiting. In certain embodiments, the steps may be performed in some different order or some steps may also be performed in parallel.

In the embodiment depicted in FIG. 2, the processing may be triggered at 210 when modified first content is received from a first user. The modified first content may be generated by applying a first effect to first content, as described above. For example, an audio portion, a visual portion, or any combination thereof of the first content may be modified according to logic defining the first effect.

In some embodiments, the modified first content may be received by a second user device associated with a second user. For example, the first user may have sent the modified first content to the second user using a communication application installed and executing on a first user device associated with the first user.

In some embodiments, the modified first content may be sent from the first user to the second user in a message to be presented to the second user at a later time through selection of the message by the second user. When included in a message, the modified first content is referred to as being sent in a non-streaming conversation.

In the alternative, the modified first content may be included in a streaming conversation, where the modified first content is presented to the second user without selection by the second user. Instead, the second user and the first user may be actively communicating with each other during the streaming conversation. For example, the first user and the second user may be connected to each other via a video or audio call that is continuously sending and presenting content from each user to the other user. In particular, content captured from a first user device associated with the first user is sent to a second user device associated with the second user while content captured from the second user device is sent to the first user device.

At 220, in response to receiving the modified first content, a second effect corresponding to the first effect may be identified. The second effect may be identified based on the first effect. To identify the first effect, the modified first content or a communication sent with the modified first content may include an identification of the first effect. For another example, the first effect may be identified in the modified first effect using a recognition process (e.g., automatic content recognition). The second effect may be identified by the second user device or by a system remote from the second user device.

After the second effect is identified, the second user device may obtain logic to implement the second effect. For example, a request may be sent from the second user device to a remote database that includes the logic to implement the second effect. For another example, the logic may be included on the second user device. In such an example, the second user device may retrieve the logic. The second user device may then present an option to respond to the modified first content using the second effect.

At 230, upon selection of the option, modified second content may be generated by applying the second effect to second content. The second effect may be applied to the second content based on logic for implementing the second effect. The logic may modify an audio or visual portion of the second content. In certain embodiments, the modified second content may be generated by the second user device. However, the modified second content may be generated by a system remote from the second user device.

At 240, after the modified second content is generated, the second user device may cause the modified second content to be communicated to the first user. For example, the second user may select an option to have the modified second content sent to the first user. In response to selection of the option, the modified second content may be sent to the first user device for presentation. When the modified second content is generated by the system, selection of the option can cause the second user device to send a message to the system to have the system send the modified second content to the first user device.

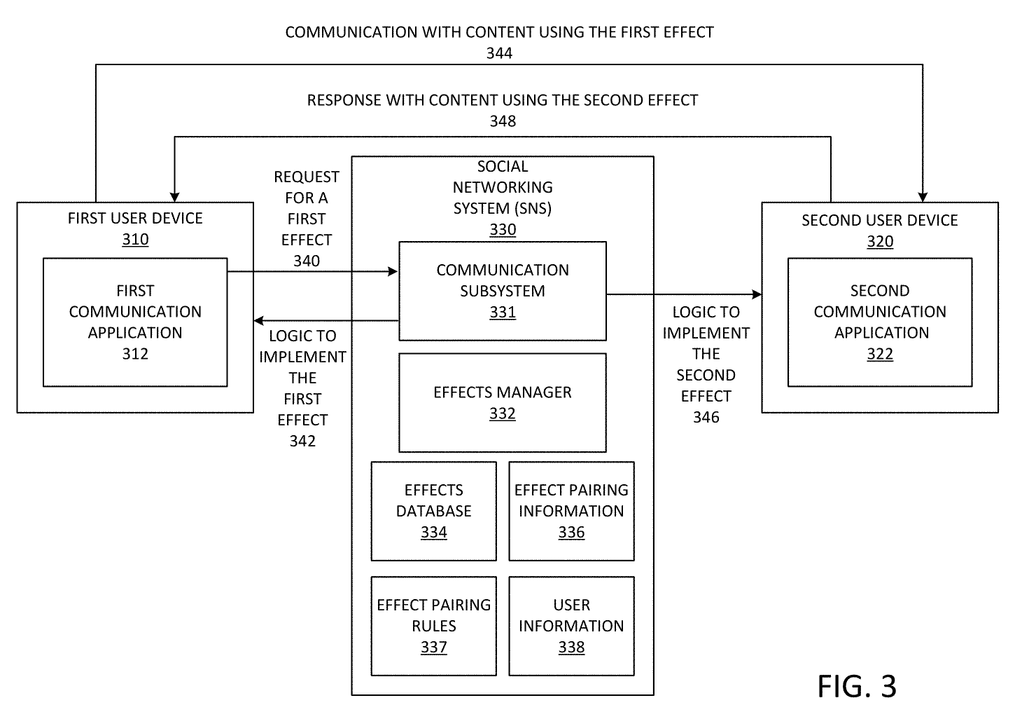

FIG. 3 is a simplified block diagram of a distributed system with social networking system (SNS) 330 according to certain embodiments. The distributed system may have SNS 330 communicatively coupled with one or more user devices (e.g., first user device 310 and second user device 320). However, the distributed system depicted in FIG. 3 is merely an example and is not intended to unduly limit the scope of inventive embodiments recited in the claims. One of ordinary skill in the art would recognize many possible variations, alternatives, and modifications. For example, in some implementations, the distributed system may have more or fewer components, may combine two or more components, or may have a different configuration or arrangement than shown in FIG. 3. In some embodiments, SNS 330 may be one or more servers. While two user devices and two users are described herein, it should be recognized that more than two user devices and/or users may be involved.

To use SNS 330, a user typically has to register an account with SNS 330. As a result of the registration, SNS 330 may create and store information about the user, often referred to as a user profile. The user profile may be stored in user information database 338, which may be included with or remote from SNS 330.

The user profile may include the user's identification information, background information, employment information, demographic information, communication channel information, personal interests, or other suitable information. Information stored by SNS 330 for a user may be updated based on the user's interactions with SNS 330 and other users of SNS 330. For example, a user may add connections to any number of other users of SNS 330 to whom they desire to be connected. The term “friend” is sometimes used to refer to any other users of SNS 330 to whom a user has formed a connection, association, or relationship via SNS 330. Connections may be added explicitly by a user or may be automatically created by SNS 330 based on common characteristics of the users (e.g., users who are alumni of the same educational institution).

SNS 330 may also store information related to the user's interactions and relationships with other concepts (e.g., users, groups, posts, pages, events, photos, audiovisual content (e.g., videos), apps, etc.) in SNS 330. SNS 330 may store the information in a social graph. The social graph may include nodes representing individuals, groups, organizations, or the like. The edges between the nodes may represent one or more specific types of interdependencies or interactions between the concepts. SNS 330 may use this stored information to provide various services (e.g., wall posts, photo sharing, event organization, messaging, games, advertisements, or the like) to its users to facilitate social interaction between users using SNS 330. In one embodiment, if users of SNS 330 are represented as nodes in the social graph, the term “friend” may refer to an edge formed between and directly connecting two user nodes.

SNS 330 may facilitate linkages between a variety of concepts, including users, groups, etc. These concepts may be represented by nodes of the social graph interconnected by one or more edges. A node in the social graph may represent a concept that may act on another node representing another concept and/or that may be acted on by the concept corresponding to the other node. A social graph may include various types of nodes corresponding to users, non-person concepts, content items, web pages, groups, activities, messages, and other things that may be represented by objects in SNS 330.

An edge between two nodes in the social graph may represent a particular kind of connection, or association, between the two nodes, which may result from node relationships or from an action that was performed by a concept represented by one of the nodes on a concept represented by the other node. In some cases, the edges between nodes may be weighted. In certain embodiments, the weight associated with an edge may represent an attribute associated with the edge, such as a strength of the connection or association between nodes. Different types of edges may be provided with different weights. For example, an edge created when one user “likes” another user may be given one weight, while an edge created when a user befriends another user may be given a different weight.

The user devices 310, 320 depicted in FIG. 3 may be communicatively coupled with each other and/or SNS 330 via one or more communication networks. Examples of a communication network include, without restriction, the Internet, a wide area network (WAN), a local area network (LAN), an Ethernet network, wireless wide-area networks (WWANs), wireless local area networks (WLANs), wireless personal area networks (WPANs), a public or private network, a wired network, a wireless network, the like, or combinations thereof. Different communication protocols may be used to facilitate communications including both wired and wireless protocols such as IEEE 802.XX suite of protocols, TCP/IP, IPX, SAN, AppleTalk®, Bluetooth®, InfiniBand, RoCE, Fiber Channel, Ethernet, User Datagram Protocol (UDP), Asynchronous Transfer Mode (ATM), token ring, frame relay, High Level Data Link Control (HDLC), Fiber Distributed Data Interface (FDDI), and/or Point-to-Point Protocol (PPP), and others. A WWAN may be a network using an air interface technology, such as, a code division multiple access (CDMA) network, a Time Division Multiple Access (TDMA) network, a Frequency Division Multiple Access (FDMA) network, an OFDMA network, a Single-Carrier Frequency Division Multiple Access (SC-FDMA) network, a WiMax (IEEE 802.16), and so on. A WLAN may include an IEEE 802.11x network (e.g., a Wi-Fi network). A WPAN may be a Bluetooth network, an IEEE 802.15x, or some other types of network.

A user device (sometimes referred to as a client device, a client, or a device) may be a computing device, such as, for example, a mobile phone, a smart phone, a personal digital assistant (PDA), a tablet computer, an electronic book (e-book) reader, a gaming console, a laptop computer, a netbook computer, a desktop computer, a thin-client device, a workstation, etc. One or more applications (“apps”) may be hosted and executed by the user device (e.g., first communication application 312 by first user device 310 and second communication application 322 by second user device 320). The apps may be web browser-based applications or other types of applications.

First communication application 312 may enable a conversation between first communication application 312 and second communication application 322. The conversation may include one or more communications exchanged between the communication applications 312, 322. For example, first communication application 312 may maintain a streaming conversation (such as a video or audio call) with second communication application 322. For another example, first communication application 312 may maintain a non-streaming conversation (e.g., a message exchange) with second communication application 322.

In some embodiments, the communication applications 312, 322 may also communicate with communication subsystem 331 of SNS 330. Communication subsystem 331 may send one or more effects to one or more of user devices 310, 320. An effect, when applied to content, may modify an audio portion, a visual portion, or any combination thereof of the content. In some cases, communication subsystem 331 may receive a request for an effect from a communication application, as illustrated by request 340 in FIG. 3. In response to the request, communication subsystem 331 may send logic for implementing the effect to the communication application, as illustrated by message 342 in FIG. 3. In other cases, communication subsystem 331 may send logic for implementing an effect to a communication application without first receiving a request for the effect, as illustrated by message 346 in FIG. 3 and further described below. In such cases, the logic may be sent based on an identification of an effect by a subsystem (e.g., effects manager 332) of SNS 330.

Effects manager 332 may determine to send logic for implementing one or more effects to a user device. The determination may be based on a current time, a location (previous, current, or future) of the user device, information regarding a user associated with the user device (e.g., information from a user profile or a social graph associated with SNS 330), a communication sent to or from the user device, any combination thereof, or the like. For example, effects manager 332 may determine that first communication application 312 sent a communication (with content having a first effect applied thereto) to second communication application 322.

Based on an identification of the first effect, effects manager 332 may (1) identify a second effect that corresponds to the first effect and (2) send logic in a message 356 to second user device 320 for implementing the second effect. The logic may be stored in effects database 334, which may be included with or remote from SNS 330. While not required, the logic may be configured such that a second user operating second user device 320 may use the logic to respond to the communication sent from first communication application 312. For example, the second user may modify second content using the logic. The modified second content may be sent to first communication application 312, as illustrated by response 348 in FIG. 3.

Effects manager 332 may identify a second effect using a variety of techniques. For example, effects manager 332 may use effect pairing information (from effect pairing information database 336) to identify the second effect. The effect pairing information may indicate pairs that correspond to each other (e.g., that the second effect corresponds to the first effect). The effect pairing information may be configured by an author of an effect, by an administrator or manager of effects manager 332, or by a user of SNS 330 (e.g., a first user operating first user device 310, a second user operating second user device 320, or a third user).

For another example, effects manager 332 may use one or more effect pairing rules (from effect pairing rules database 337) to identify the second effect. An effect pairing rule may include logic that identifies the second effect based on the first effect. In some cases, the logic may use information associated with the first effect, a first user who sent content with the first effect applied thereto, a recipient of the content sent by the first user, information associated with the first user and/or the second user (e.g., information from a user profile or a social graph associated with SNS 330), any combination thereof, or the like.

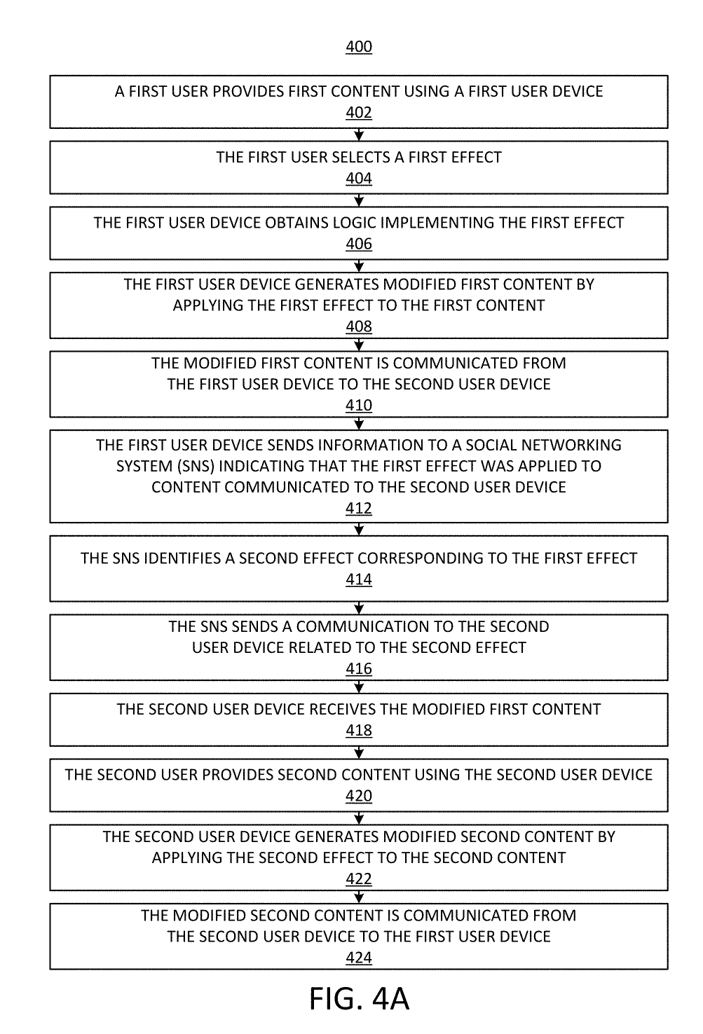

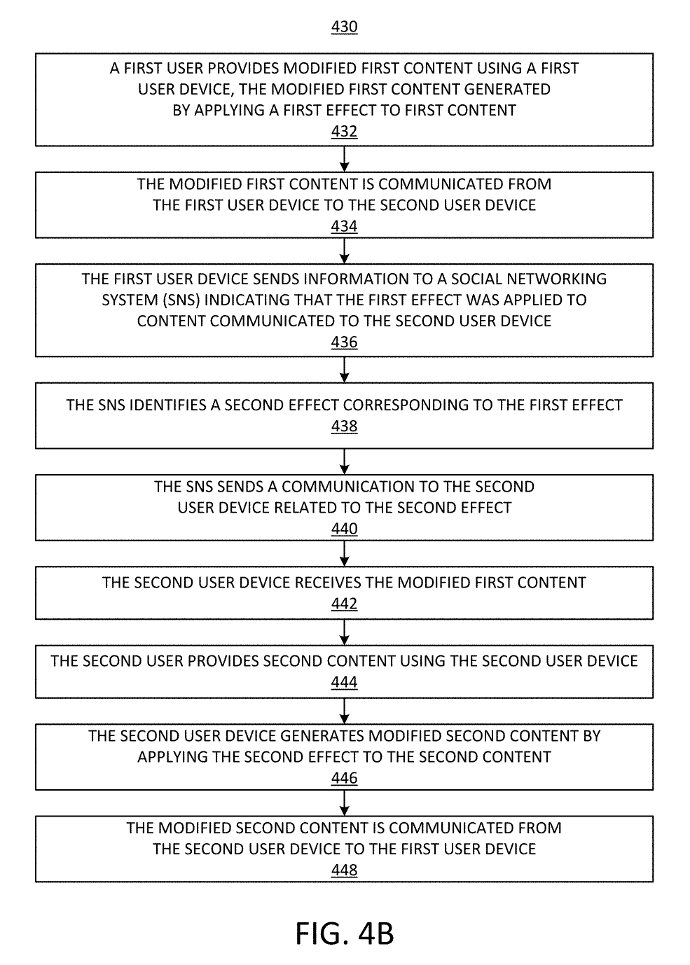

FIG. 4A is a simplified flowchart depicting processing performed in a distributed system for implementing paired effects when content is modified on a user device according to certain embodiments. The processing depicted in FIG. 4A may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 4A and described below is intended to be illustrative and non-limiting. Although FIG. 4A depicts the various processing steps occurring in a particular sequence or order, this is not intended to be limiting. In certain embodiments, the steps may be performed in some different order or some steps may also be performed in parallel.

In the embodiment depicted in FIG. 4A, the processing may be triggered at 402 when a first user provides first content using a first user device. The first content may be audio, visual, or any combination thereof. At 404, the first user may select a first effect. The first effect may be associated with logic that causes the first effect to be applied to the first content. At 406, the first user device may obtain logic implementing the first effect. For example, the first user device may send a request for the first effect to a social networking system (SNS). For another example, the first user device may send a request to a storage location included on the first user device.

At 408, the first user device may generate modified first content by applying the first effect to the first content. At 410, the modified first content may be communicated from the first user device to a second user device. At 412, the first user device may send information to the SNS indicating that the first effect was applied to content communicated to the second user device. At 414, the SNS may identify a second effect corresponding to the first effect. At 416, the SNS may send a communication to the second user device related to the second effect. For example, the communication may identify the second effect or include logic for implementing the second effect.

At 418, the second user device may receive the modified first content. At 420, the second user may provide second content using the second user device. The second content may be provided in response to the modified first content. At 422, the second user device may generate modified second content by applying the second effect to the second content. At 424, the modified second content may be communicated from the second user device to the first user device.

FIG. 4B is a simplified flowchart depicting processing performed in a distributed system for implementing paired effects when modified content is selected on a user device according to certain embodiments. The processing depicted in FIG. 4B may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 4B and described below is intended to be illustrative and non-limiting. Although FIG. 4B depicts the various processing steps occurring in a particular sequence or order, this is not intended to be limiting. In certain embodiments, the steps may be performed in some different order or some steps may also be performed in parallel.

In the embodiment depicted in FIG. 4B, the processing may be triggered at 432 when a first user provides modified first content using a first user device. The modified first content may be generated by applying a first effect to first content. In some examples, the modified first content may be generated by the first user device. In other examples, the modified first content may be generated by another device.

At 434, the modified first content may be communicated from the first user device to the second user device. At 436, the first user device may send information to a social networking system (SNS) indicating that the first effect was applied to content communicated to the second user device.

At 438, the SNS may identify a second effect corresponding to the first effect. At 440, the SNS may send a communication to the second user device related to the second effect. For example, the communication can include an identification of the second effect or logic to implement the second effect.

At 442, the second user device may receive the modified first content. At 444, the second user may provide second content using the second user device. The second content may be provided in response to the modified first content. Next, the second user may indicate using the second user device to apply the second effect to the second content. At 446, the second user device may generate modified second content by applying the second effect to the second content. At 448, the modified second content may be communicated from the second user device to the first user device.

In some examples, the modified first content and the modified second content may be included in a streaming conversation that is established between the first user device and the second user device. It should be recognized that any component may establish the streaming conversation, including the SNS, the first user device, the second user device, or any combination thereof. In one illustrative example, the streaming conversation may be a video or an audio call. The streaming conversation may be maintained via a first communication application of the first user device and a second communication application of the second user device. For example, each of the first communication application and the second communication application may present content from the streaming conversation. In one illustrative example, the first communication application may display video content from the second user device, and the second communication application may display video content from the first user device. Each communication application may also display content from their own user device.

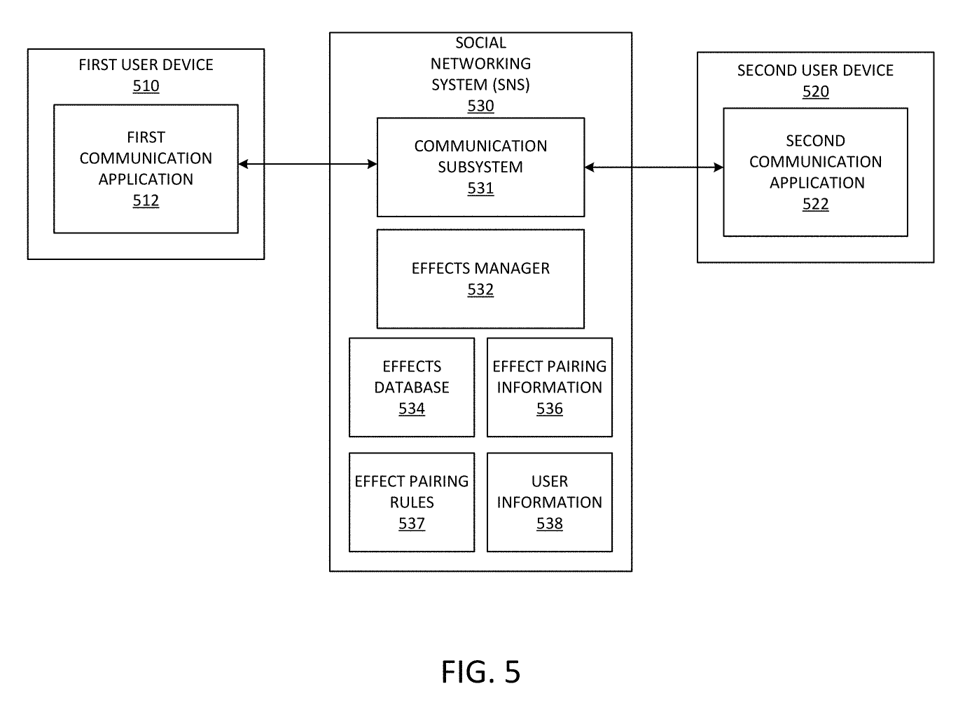

FIG. 5 is a simplified block diagram of a distributed system with social networking system (SNS) 530 managing communications in the distributed system according to certain embodiments. The distributed system may have SNS 530 communicatively coupled with one or more user devices (e.g., first user device 510 and second user device 520). However, the distributed system depicted in FIG. 5 is merely an example and is not intended to unduly limit the scope of inventive embodiments recited in the claims. One of ordinary skill in the art would recognize many possible variations, alternatives, and modifications. For example, in some implementations, the distributed system may have more or fewer components, may combine two or more components, or may have a different configuration or arrangement than shown in FIG. 5. In some embodiments, SNS 530 may be one or more servers. The SNS 530 may have one or more features described above in FIG. 3 for SNS 330.

The user devices 510, 520 depicted in FIG. 5 may be communicatively coupled with SNS 530 via one or more communication networks. SNS 530 may communicatively couple the user devices through SNS 530. For example, a communication sent from a first user to a second user may go through SNS 530 to get to the second user. One or more applications (“apps”) may be hosted and executed by each of user devices 510, 520 (e.g., first communication application 512 by first user device 510 and second communication application 522 by second user device 520).

First communication application 512 may enable a conversation between first communication application 512 and second communication application 522. The conversation may include one or more communications exchanged between the communication applications. For example, first communication application 512 may maintain a streaming conversation (such as a video or audio call) with second communication application 522. For another example, first communication application 512 may maintain a non-streaming conversation (e.g., a message exchange) with second communication application 522.

Communications between user devices 510, 520 may be sent through communication subsystem 531 of SNS 530. For example, communication subsystem 531 may maintain a streaming conversation (such as a video or audio call) between first user device 510 and second user device 520. For another example, communication subsystem 531 may forward a message in a non-streaming conversation that is sent from first communication application 512 to second communication application 522 (i.e., first communication application 512 may send the message to communication subsystem 531, which forwards the message to second communication application 522).

While two user devices and two users are described above, it should be recognized that more than two user devices and/or users may be present. In addition, it should be recognized that conversations may be between users rather than user devices. Accordingly, communications may be sent from user devices to users, which communication subsystem 531 then forwards to one or more devices associated with the users.

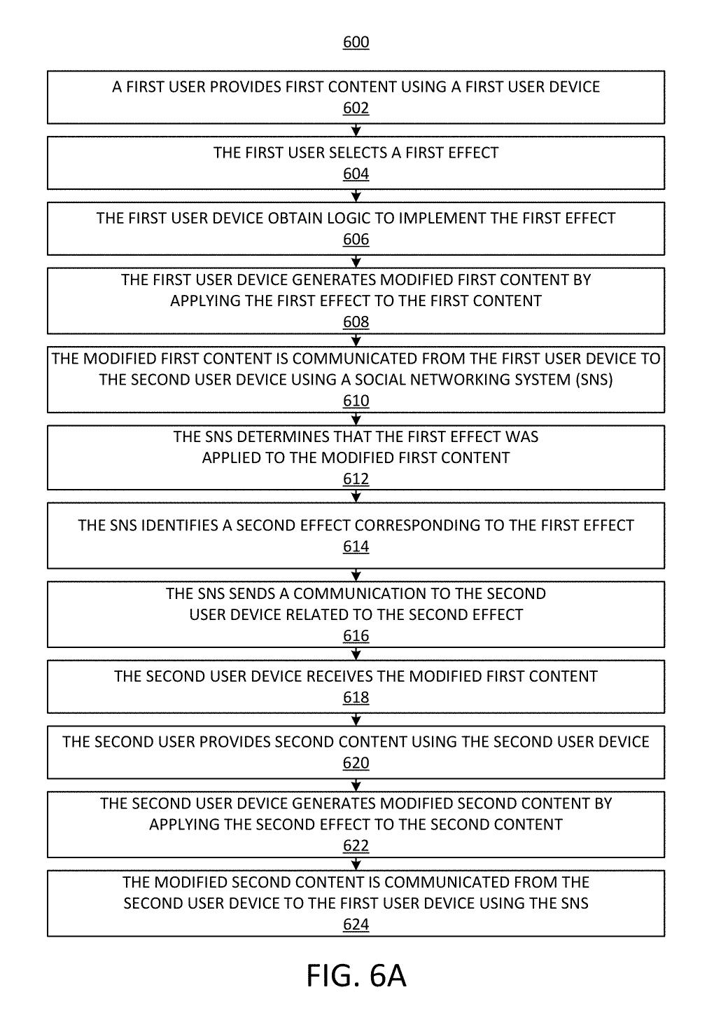

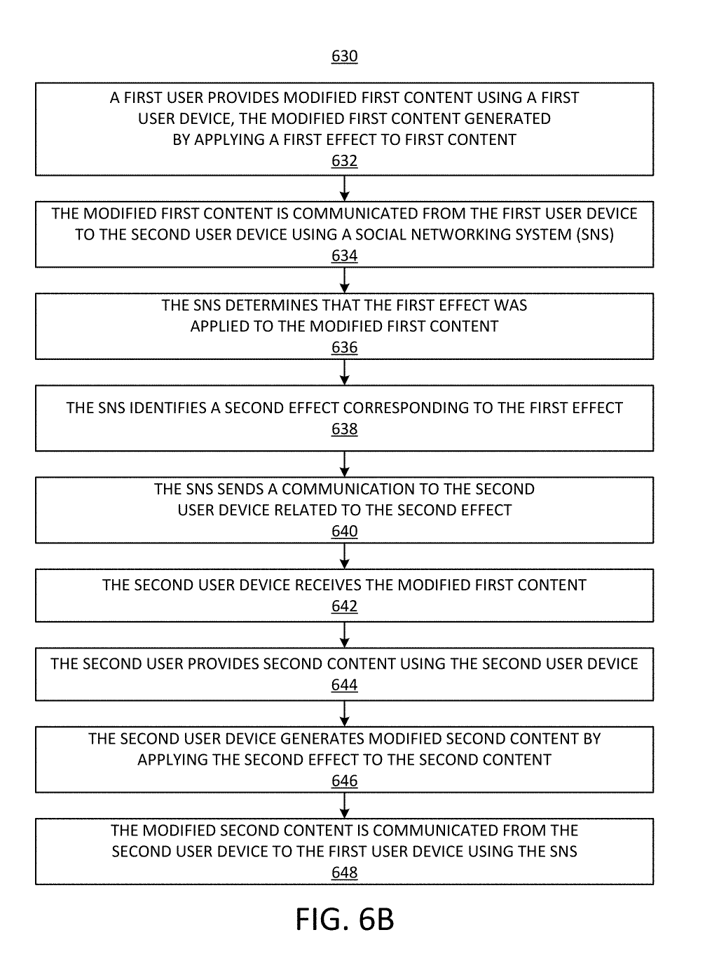

FIG. 6A is a simplified flowchart depicting processing performed in a distributed system for implementing paired effects with a social networking system (SNS) managing communications in the distributed system when content is modified on a user device according to certain embodiments. The processing depicted in FIG. 6A may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 6A and described below is intended to be illustrative and non-limiting. Although FIG. 6A depicts the various processing steps occurring in a particular sequence or order, this is not intended to be limiting. In certain embodiments, the steps may be performed in some different order or some steps may also be performed in parallel.

In the embodiment depicted in FIG. 6A, the processing may be triggered at 602 when a first user provides first content using a first user device. The first content may include audio and/or visual components. The first content may be stored by the first user device or a remote system. The first content may be captured by a component of the first user device. For example, the first user device may include a camera that captures an image or video. The image or the video may be the first content.

The first user device may present one or more effects to the first user, the one or more effects including a first effect. At 604, the first user may select the first effect. At 606, the first user device may obtain logic to implement the first effect. For example, the first user device may send a request to the SNS for the logic. In response to the request, the SNS may send the logic to the first user device. For another example, the first user device may include a storage subsystem that has the logic.

At 608, the first user device may generate modified first content by applying the first effect to the first content. For example, the logic may modify an audio and/or visual portion of the first content. At 610, the modified first content may be communicated from the first user device to the second user device using a social networking system (SNS). For example, the first user may send the modified first content to the SNS, and the SNS may send the modified first content to the second user device.

At 612, the SNS may determine that the first effect was applied to the modified first content. Determining may be based on an identification of the first effect sent with or in addition to the modified first content. In some examples, a recognition system may be used to determine that the first effect was applied to the modified first content.

At 614, the SNS may identify a second effect corresponding to the first effect. The second effect may be identified based upon (1) pairing information that indicates pairs of effects, (2) pairing logic that determines the second effect based upon the first effect, (3) information stored by the SNS regarding the first user, a second user associated with the second user device, or the like, (3) any combination thereof, (4) or the like.

At 616, the SNS may send a communication to the second user device related to the second effect. For example, the communication may identify the second effect. For another example, the communication may include logic to implement the second effect.

At 618, the second user device may receive the modified first effect. At 620, the second user may provide second content using the second user device. The second content may be provided similarly as described above for 602. At 622, the second user device may generate modified second content by applying the second effect to the second content, similarly as described above at 608. At 624, the modified second content may be communicated from the second user device to the first user device using the SNS. For example, the modified second content may be sent from the second user device to the SNS, and the SNS may send the modified second content to the first user device.

FIG. 6B is a simplified flowchart depicting processing performed in a distributed system for implementing paired effects with a social networking system managing communications in the distributed system when modified content is selected on a user device according to certain embodiments. The processing depicted in FIG. 6B may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 6B and described below is intended to be illustrative and non-limiting. Although FIG. 6B depicts the various processing steps occurring in a particular sequence or order, this is not intended to be limiting. In certain embodiments, the steps may be performed in some different order or some steps may also be performed in parallel.

In the embodiment depicted in FIG. 6B, the processing may be triggered at 632 when a first user provides modified first content using a first user device. The modified first content may be generated by applying a first effect to first content. However, unlike described in FIG. 6A, the modified first content in FIG. 6B may already be modified when it is provided by the first user device. For example, a different device may have modified the first content by applying the first effect.

At 634, the modified first content may communicated from the first user device to the second user device using a social networking system (SNS). For example, the first user device may send the modified first content to the SNS, and the SNS may forward the modified first content to the second user device.

At 636, the SNS may determine that the first effect was applied to the modified first content, similar to as described above at 612 in FIG. 6A. At 638, the SNS may identify a second effect corresponding to the first effect, similar to as described above at 614 in FIG. 6A. At 640, the SNS may send a communication to the second user device, the communication related to the second effect. Similar to as described above, the communication may include an identification of the second effect or logic to implement the second effect.

At 642, the second user device may receive the modified first content. At 644, the second user may provide second content using the second user device. At 646, the second user device may generate modified second content by applying the second effect to the second content. At 648, the modified second content may be communicated from the second user device to the first user device using the SNS. For example, the modified second content may be sent from the second user device to the SNS, and the SNS may send the modified second content to the first user device.

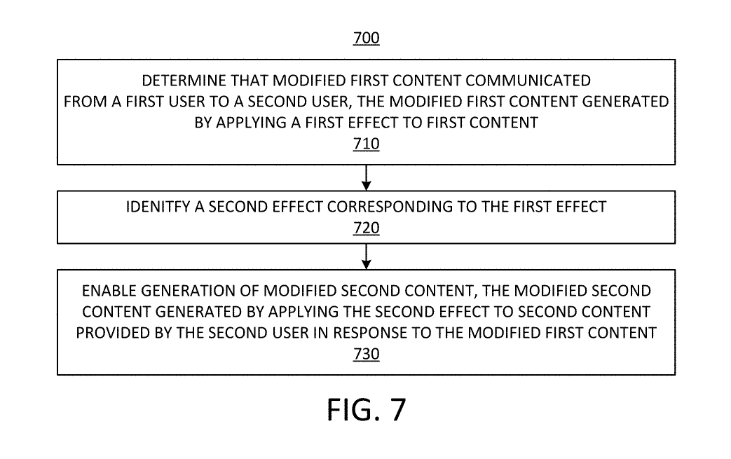

FIG. 7 is a simplified flowchart depicting processing performed by a social networking system for implementing paired effects according to certain embodiments. The processing depicted in FIG. 7 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 7 and described below is intended to be illustrative and non-limiting. Although FIG. 7 depicts the various processing steps occurring in a particular sequence or order, this is not intended to be limiting. In certain embodiments, the steps may be performed in some different order or some steps may also be performed in parallel.

In the embodiment depicted in FIG. 7, the processing may be triggered at 710 when it is determined that modified first content has been communicated from a first user to a second user, the modified first content generated by applying a first effect to first content. The first effect may modify an audio portion or a visual portion of the first content.

In some examples, the modified first content may be generated by the first user device. In such examples, the first content may be received by the first user device or captured by a component of the first user device (e.g., a camera or an audio recorder). In addition, logic for implementing the first effect may be received by the first user device in response to the first user device sending a request for the first effect. The request may be sent to a SNS as described herein. In other examples, the modified first content may be received by the first user device. In other examples, the modified first content may be generated by a user device other than the first user device (e.g., a third user device or the SNS). In other examples, the modified first content may be generated by the SNS.

The determining may be performed by a computer system (e.g., a SNS as illustrated in FIGS. 3 and 5 or a user device as illustrated in FIGS. 1, 3, and 5). The first user may be associated with a first account of the SNS and the second user may be associated with a second account of the SNS.

In some embodiments, a computer system (e.g., a SNS as illustrated in FIGS. 3 and 5 or a user device as illustrated in FIGS. 1, 3, and 5) may enable communication of the modified first content from the first user to the second user. The computer system that enables the communication may be the same or different than the computer system that performs the determining described above. When the computer system enabling the communication is a SNS, the SNS may receive the modified first content from a device associated with the first user (sometimes referred to as a first user device) and forward the modified first content to a device associated with the second user (sometimes referred to as a second user device). When the computer system enabling the communication is the first user device, the first user device may send the modified first content to the second user device without sending the modified first content to a SNS.

The modified first content may be associated with a streaming or non-streaming conversation. A streaming conversation may be one that includes a communication that is presented by a device in response to the device receiving the communication. For example, the streaming conversation may be a video or audio call that is established between the first user device and the second user device. The video or audio call may include video frames and/or audio segments that are captured by each of the first user device and the second user device and sent to the other device on the video or audio call. For example, the modified first content may be a portion of the streaming conversation from the first user device. When the modified first content is associated with a streaming conversation, the SNS (or the second user device) may receive a request to establish the streaming conversation between the first user and the second user. In response to the request, the streaming conversation between the first user and the second user may be established.

A non-streaming conversation may be one that includes a communication that is presented by a receiving device in response to the receiving device indicating to view the communication. For example, the non-streaming conversation may be an exchange of messages (e.g., an email, a text message, a voicemail, a picture message, a video message, or the like) between the first user device and the second user device. When the modified first content is associated with a non-streaming conversation, the modified first content may be communicated from the first user to the second user in a first message.

At 720, a second effect corresponding to the first effect may be identified. The second effect may be different than the first effect. The second effect may be identified by a computer system (e.g., a SNS as illustrated in FIGS. 3 and 5 or a user device as illustrated in FIGS. 1, 3, and 5). The computer system that identified the second effect may be the same or different computer system described above with reference to FIG. 1. The second effect may be identified based on the first effect, logic defined for the first effect, information associated with the first user or the second user, the like, or any combination thereof. In some examples, identifying the second effect is performed in response to the first user communicating the modified first content.

At 730, generation of modified second content may be enabled. The modified second content may be generated by a computer system (e.g., a SNS as illustrated in FIGS. 3 and 5 or a user device as illustrated in FIGS. 1, 3, and 5). The computer system that generates the modified second content may be the same or different computer system described above with reference to FIG. 7. The modified second content may be generated by applying the second effect to second content provided by the second user in response to the modified first content. In some embodiments, the second user device may receive logic to implement the second effect in response to the second user device requesting the second effect. In such embodiments, the request for the second effect may be sent to a system separate from the second user device, such as a database or a SNS. In other embodiments, the logic for implementing the second effect may be sent to the second user device without a request for the second effect.

In some embodiments, a computer system (e.g., a SNS as illustrated in FIGS. 3 and 5 or a user device as illustrated in FIGS. 1, 3, and 5) may enable communication of the modified second content from the second user to the first user. The computer system that enables the communication may be the same or different computer system described above with reference to FIG. 7. When the computer system enabling the communication is a SNS, the SNS may receive the modified second content from the second user device and forward the modified second content to the first user device. When the computer system enabling the communication is the second user device, the second user device may send the modified second content to the first user device without sending the modified second content to a SNS. In some examples, the modified second content may be a portion of the streaming conversation.

In embodiments described above, modified content is sent from a first user device to a second user device. Other embodiments may modify content after it is received at a user device for presentation (sometimes referred to as deferred rendering or consumption-time rendering). In such embodiments, the content and an effect (e.g., an identification of the effect or logic to implement the effect) may be sent from a first user device to a second user device. The second user device may then generate (sometimes referred to as render) modified content by applying the effect to the content.

In some embodiments, content may be modified by a server (such as a SNS) instead of a user device. For example, rather than a user device modifying content to add an effect, the user device may send the content to a SNS, the SNS may modify the content based on the effect, and the SNS may send the content back to the user device such that the user device may view the modified content without having to modify the content on the user device. By having the SNS modify the content, the user device does not need to download the effect and/or execute logic to have the effect applied to the content. In such embodiments, the user device may determine whether the user device is below a threshold, which may be set by the SNS. When the user device is below the threshold, the user device may automatically send content to the SNS for modification rather than modifying the content on the user device. Of course, it should be recognized that the user device may choose to have the content modified by the SNS. For example, the user device might not want to download effects to the user device.

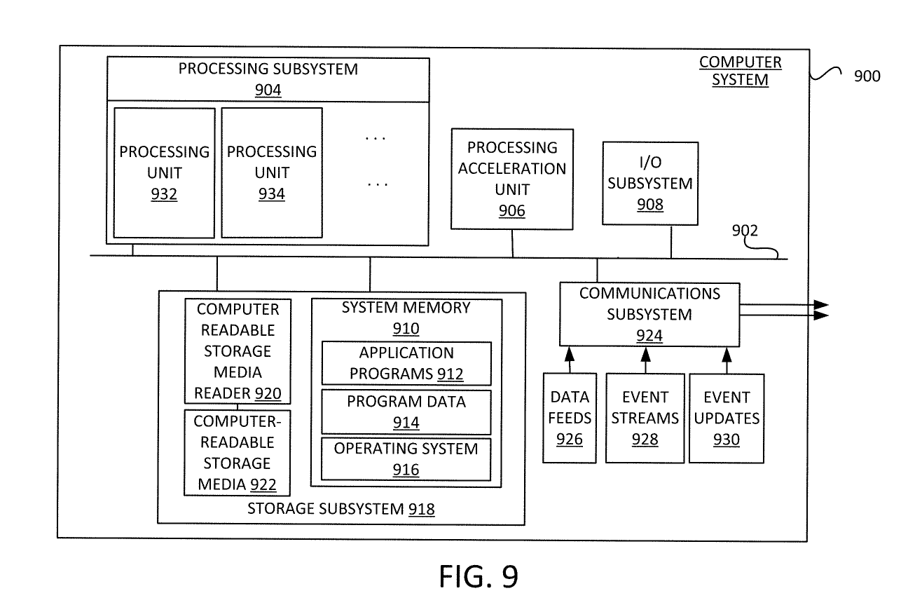

FIG. 9 illustrates an example of computer system 900, which may be used to implement certain embodiments described herein. For example, in some embodiments, computer system 900 may be used to implement any of the systems, servers, devices, or the like described above. As shown in FIG. 9, computer system 900 includes various subsystems including processing subsystem 904 that communicates with a number of other subsystems via bus subsystem 902. These other subsystems may include processing acceleration unit 906, I/O subsystem 908, storage subsystem 918, and communications subsystem 924. Storage subsystem 918 may include non-transitory computer-readable storage media including storage media 922 and system memory 910.

Bus subsystem 902 provides a mechanism for letting the various components and subsystems of computer system 900 communicate with each other as intended. Although bus subsystem 902 is shown schematically as a single bus, alternative embodiments of bus subsystem 902 may utilize multiple buses. Bus subsystem 902 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P1386.1 standard, and the like.

Processing subsystem 904 controls the operation of computer system 900 and may comprise one or more processors, application specific integrated circuits (ASICs), or field programmable gate arrays (FPGAs). The processors may include single core and/or multicore processors. The processing resources of computer system 900 may be organized into one or more processing units 932, 934, etc. A processing unit may include one or more processors, one or more cores from the same or different processors, a combination of cores and processors, or other combinations of cores and processors. In some embodiments, processing subsystem 904 may include one or more special purpose co-processors such as graphics processors, digital signal processors (DSPs), or the like. In some embodiments, some or all of the processing units of processing subsystem 904 may be implemented using customized circuits, such as application specific integrated circuits (ASICs), or field programmable gate arrays (FPGAs).

In some embodiments, the processing units in processing subsystem 904 may execute instructions stored in system memory 910 or on computer readable storage media 922. In various embodiments, the processing units may execute a variety of programs or code instructions and may maintain multiple concurrently executing programs or processes. At any given time, some or all of the program code to be executed may be resident in system memory 910 and/or on computer-readable storage media 922 including potentially on one or more storage devices. Through suitable programming, processing subsystem 904 may provide various functionalities described above. In instances where computer system 900 is executing one or more virtual machines, one or more processing units may be allocated to each virtual machine.

In certain embodiments, processing acceleration unit 906 may optionally be provided for performing customized processing or for off-loading some of the processing performed by processing subsystem 904 so as to accelerate the overall processing performed by computer system 900.

I/O subsystem 908 may include devices and mechanisms for inputting information to computer system 900 and/or for outputting information from or via computer system 900. In general, use of the term input device is intended to include all possible types of devices and mechanisms for inputting information to computer system 900. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices that enable users to control and interact with an input device and/or devices that provide an interface for receiving input using gestures and spoken commands. User interface input devices may also include eye gesture recognition devices that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments and the like.

In general, use of the term output device is intended to include all possible types of devices and mechanisms for outputting information from computer system 900 to a user or other computer system. User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. For example, user interface output devices may include, without limitation, a variety of display devices that visually convey text, graphics and audio/video information such as monitors, printers, speakers, headphones, automotive navigation systems, plotters, voice output devices, and modems.

Storage subsystem 918 provides a repository or data store for storing information and data that is used by computer system 900. Storage subsystem 918 provides a tangible non-transitory computer-readable storage medium for storing the basic programming and data constructs that provide the functionality of some embodiments. Storage subsystem 918 may store software (e.g., programs, code modules, instructions) that when executed by processing subsystem 904 provides the functionality described above. The software may be executed by one or more processing units of processing subsystem 904. Storage subsystem 918 may also provide a repository for storing data used in accordance with the teachings of this disclosure.

Storage subsystem 918 may include one or more non-transitory memory devices, including volatile and non-volatile memory devices. As shown in FIG. 9, storage subsystem 918 includes system memory 910 and computer-readable storage media 922. System memory 910 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 900, such as during start-up, may typically be stored in the ROM. The RAM typically contains data and/or program modules that are presently being operated and executed by processing subsystem 904. In some implementations, system memory 910 may include multiple different types of memory, such as static random access memory (SRAM), dynamic random access memory (DRAM), and the like.

By way of example, and not limitation, as depicted in FIG. 9, system memory 910 may load application programs 912 that are being executed, which may include various applications such as Web browsers, mid-tier applications, relational database management systems (RDBMS), etc., program data 914, and operating system 916.

Computer-readable storage media 922 may store programming and data constructs that provide the functionality of some embodiments. Computer-readable media 922 may provide storage of computer-readable instructions, data structures, program modules, and other data for computer system 900. Software (programs, code modules, instructions) that, when executed by processing subsystem 904 provides the functionality described above, may be stored in storage subsystem 918. By way of example, computer-readable storage media 922 may include non-volatile memory such as a hard disk drive, a magnetic disk drive, an optical disk drive such as a CD ROM, DVD, a Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs.

In certain embodiments, storage subsystem 918 may also include computer-readable storage media reader 920 that may further be connected to computer-readable storage media 922. Reader 920 may receive and be configured to read data from a memory device such as a disk, a flash drive, etc.

In certain embodiments, computer system 900 may support virtualization technologies, including but not limited to virtualization of processing and memory resources. For example, computer system 900 may provide support for executing one or more virtual machines. In certain embodiments, computer system 900 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 900. Accordingly, multiple operating systems may potentially be run concurrently by computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 900 to establish a communication channel to one or more client devices via the Internet for receiving and sending information from and to the client devices. For example, when computer system 900 is used to implement social networking system (SNS) 330 depicted in FIG. 3 or SNS 530 depicted in FIG. 5, communication subsystem 924 may be used to communicate with user devices (e.g., first user device 310, 510 and second user device 320, 520).

Communication subsystem 924 may support both wired and/or wireless communication protocols. For example, in certain embodiments, communications subsystem 924 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.XX family standards, or other mobile communication technologies, or any combination thereof), global positioning system (GPS) receiver components, and/or other components. In some embodiments, communications subsystem 924 may provide wired network connectivity (e.g., Ethernet) in addition to or instead of a wireless interface.

Communication subsystem 924 may receive and transmit data in various forms. For example, in some embodiments, in addition to other forms, communications subsystem 924 may receive input communications in the form of structured and/or unstructured data feeds 926, event streams 928, event updates 930, and the like. For example, communications subsystem 924 may be configured to receive (or send) data feeds 926 in real-time from users of social media networks and/or other communication services such as web feeds and/or real-time updates from one or more third party information sources.

In certain embodiments, communications subsystem 924 may be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 924 may also be configured to communicate data from computer system 900 to other computer systems or networks. The data may be communicated in various different forms such as structured and/or unstructured data feeds 926, event streams 928, event updates 930, and the like to one or more databases that may be in communication with one or more streaming data source computers coupled to computer system 900.

Computer system 900 may be one of various types, including a handheld portable device, a wearable device, a personal computer, a workstation, a mainframe, a kiosk, a server rack, or any other data processing system. Due to the ever-changing nature of computers and networks, the description of computer system 900 depicted in FIG. 9 is intended only as a specific example. Many other configurations having more or fewer components than the system depicted in FIG. 9 are possible. Based on the disclosure and teachings provided herein, a person of ordinary skill in the art will appreciate other ways and/or methods to implement the various embodiments.

Some embodiments described herein make use of social networking data that may include information voluntarily provided by one or more users. In such embodiments, data privacy may be protected in a number of ways.

For example, the user may be required to opt in to any data collection before user data is collected or used. The user may also be provided with the opportunity to opt out of any data collection. Before opting in to data collection, the user may be provided with a description of the ways in which the data will be used, how long the data will be retained, and the safeguards that are in place to protect the data from disclosure.

Any information identifying the user from which the data was collected may be purged or disassociated from the data. In the event that any identifying information needs to be retained (e.g., to meet regulatory requirements), the user may be informed of the collection of the identifying information, the uses that will be made of the identifying information, and the amount of time that the identifying information will be retained. Information specifically identifying the user may be removed and may be replaced with, for example, a generic identification number or other non-specific form of identification.

Once collected, the data may be stored in a secure data storage location that includes safeguards to prevent unauthorized access to the data. The data may be stored in an encrypted format. Identifying information and/or non-identifying information may be purged from the data storage after a predetermined period of time.

Although particular privacy protection techniques are described herein for purposes of illustration, one of ordinary skill in the art will recognize that privacy protected in other manners as well.

In the preceding description, for the purposes of explanation, specific details are set forth in order to provide a thorough understanding of examples of the disclosure. However, it should be apparent that various examples may be practiced without these specific details. For example, circuits, systems, networks, processes, and other components may be shown as components in block diagram form in order to not obscure the examples in unnecessary detail. In other instances, well-known circuits, processes, algorithms, structures, and techniques may have been shown without necessary detail in order to avoid obscuring the examples. The figures and description are not intended to be restrictive.

The description provides examples only, and is not intended to limit the scope, applicability, or configuration of the disclosure. Rather, the description of the examples provides those skilled in the art with an enabling description for implementing an example. It should be understood that various changes may be made in the function and arrangement of elements without departing from the spirit and scope of the disclosure as set forth in the appended claims.

Also, it is noted that individual examples may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

The term “machine-readable storage medium” or “computer-readable storage medium” includes, but is not limited to, portable or non-portable storage devices, optical storage devices, and various other mediums capable of storing, containing, or carrying instruction(s) and/or data. A machine-readable storage medium or computer-readable storage medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements.

Furthermore, examples may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. One or more processors may execute the software, firmware, middleware, microcode, the program code, or code segments to perform the necessary tasks.

Systems depicted in some of the figures may be provided in various configurations. In some embodiments, the systems may be configured as a distributed system where one or more components of the system are distributed across one or more networks such as in a cloud computing system.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The terms and expressions that have been employed in this disclosure are used as terms of description and not of limitation, and there is no intention in the use of such terms and expressions of excluding any equivalents of the features shown and described or portions thereof.

It is recognized, however, that various modifications are possible within the scope of the systems and methods claimed. Thus, it should be understood that, although certain concepts and techniques have been specifically disclosed, modification and variation of these concepts and techniques may be resorted to by those skilled in the art, and that such modifications and variations are considered to be within the scope of the systems and methods as defined by this disclosure.

Although specific embodiments have been described, various modifications, alterations, alternative constructions, and equivalents are possible. Embodiments are not restricted to operation within certain specific data processing environments, but are free to operate within a plurality of data processing environments. Additionally, although certain embodiments have been described using a particular series of transactions and steps, it should be apparent to those skilled in the art that this is not intended to be limiting. Although some flowcharts describe operations as a sequential process, many of the operations may be performed in parallel or concurrently. In addition, the order of the operations may be rearranged. A process may have additional steps not included in the figure. Various features and aspects of the above-described embodiments may be used individually or jointly.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented as a computer program product containing computer program code or instructions executable by one or more processors for performing any or all of the steps, operations, or processes described in this disclosure, where the computer program may be stored on a non-transitory computer readable medium. The various processes described herein may be implemented on the same processor or different processors in any combination.

Where devices, systems, components or modules are described as being configured to perform certain operations or functions, such configuration may be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes may communicate using a variety of techniques including but not limited to conventional techniques for inter-process communications, and different pairs of processes may use different techniques, or the same pair of processes may use different techniques at different times.

Specific details are given in this disclosure to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of other embodiments. Rather, the preceding description of the embodiments will provide those skilled in the art with an enabling description for implementing various embodiments. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A method comprising:
determining, at a computer system, that modified first content communicated from a first user to a second user has been generated by applying a first effect to first content;
identifying, by the computer system, a second effect corresponding to the first effect; and
enabling, by the computer system, generation of modified second content, the modified second content generated by applying the second effect to second content provided by the second user in response to the modified first content.

2. The method of claim 1, further comprising:
enabling, by the computer system, communication of the modified first content from the first user to the second user; and
enabling, by the computer system, communication of the modified second content from the second user to the first user.

3. The method of claim 1, wherein the first effect modifies an audio portion or a visual portion of the first content.

4. The method of claim 1, wherein the first user and the second user are participating in a streaming conversation, wherein the modified first content is a portion of the streaming conversation, and wherein the modified second content is a portion of the streaming conversation.

5. The method of claim 1, further comprising:
receiving, by the computer system, a request to establish a streaming conversation between the first user and the second user; and
establishing, by the computer system, a streaming conversation between the first user and the second user.

6. The method of claim 1, wherein the modified first content is communicated from the first user to the second user in a first message.

7. The method of claim 1, wherein identifying the second effect is based on the first effect.

8. The method of claim 1, wherein identifying the second effect is based on logic defined for the first effect.

9. The method of claim 1, wherein identifying the second effect is based on information associated with the first user or the second user.

10. The method of claim 1, wherein identifying the second effect is performed in response to the first user communicating the modified first content.

11. The method of claim 1, wherein the enabling includes sending, to the second user, logic for implementing the second effect.

12. The method of claim 1, further comprising:
receiving, by the computer system, a request for the second effect; and
sending, by the computer system, logic for implementing the second effect.

13. The method of claim 1, further comprising:
receiving, by the computer system from the first user, a request for the first effect; and
sending, by the computer system to the first user, logic for implementing the first effect.

14. The method of claim 1, further comprising:
receiving, by the computer system from the first user, the modified first content; and
sending, by the computer system, the modified first content to the second user.

15. The method of claim 1, wherein the second effect is different than the first effect.

16. The method of claim 1, wherein the first user is associated with a first account of a social networking system, and wherein the second user is associated with a second account of the social networking system.

17. A non-transitory computer-readable storage medium storing a plurality of instructions executable by one or more processors, the plurality of instructions when executed by the one or more processors cause the one or more processors to:
determine that modified first content communicated from a first user to a second user has been generated by applying a first effect to first content;
identify a second effect corresponding to the first effect; and
enable generation of modified second content, the modified second content generated by applying the second effect to second content provided by the second user in response to the modified first content.

18. A method comprising:
receiving, by a device associated with a second user, modified first content from a first user, the modified first content generated by applying a first effect to first content;
identifying a second effect corresponding to the first effect;
generating, in response to receiving the modified first content, modified second content by applying the second effect to second content; and
causing, by the device, the modified second content to be communicated to the first user.

19. The method of claim 18, wherein the determining is performed by the device.

20. The method of claim 18, wherein the generating is performed by the device.
